(19) United States
(12) Patent Application Publication
(10) Pub. No.: US 2018/0027833 A1
(43) Pub. Date: Feb. 1, 2018

(54) SHELF-STABLE FERMENTED DAIRY PRODUCTS AND METHODS OF MAKING SAME

(71) Applicant: NESTEC S.A., Vevey (CH)

(72) Inventors: Ana Lucia WIESSEL, Spring Lake, MI (US); Frank Karl WELCH, Kentwood, MI (US); Allen Bruce ZERLAUT, Fremont, MI (US)

(21) Appl. No.: 15/726,564

(22) Filed: Oct. 6, 2017

Related U.S. Application Data
(63) Continuation of application No. 14/784,980, filed on Oct. 16, 2015.
Application No. 14/784,980 is a continuation-in-part of application No. 13/265,649, filed on Dec. 21, 2011.
(60) Provisional application No. 61/172,443, filed on Apr. 24, 2009.

(51) Int. Cl. A23C 9/133; A23C 13/16; A23C 9/137; A23C 17/02

(52) U.S. Cl. CPC A23C 9/133; A23C 17/02; A23C 9/137; A23C 13/16

(57) ABSTRACT

Shelf-stable fermented dairy products, as well as methods of making and using same, are provided. The shelf-stable fermented dairy products can be shelf-stable with improved taste, viscosity, and/or texture profiles.

### CROSS-REFERENCE TO RELATED APPLICATIONS/INCORPORATION BY REFERENCE STATEMENT

This application is a continuation of U.S. Ser. No. 14/784,980, filed Oct. 16, 2015; which is a US national stage application filed under 35 USC § 371 of International Application No. PCT/IB2013/053000, filed Apr. 16, 2013. This application is also a continuation-in-part of U.S. Ser. No. 13/265,649, filed Dec. 21, 2011; which is a US national stage application filed under 35 USC § 371 of International Application No. PCT/US10/32263, filed Apr. 23, 2010, which claims priority to U.S. Ser. No. 61/172,443, filed Apr. 24, 2009. The entire contents of the above-referenced patent applications are hereby expressly incorporated herein by reference.

### BACKGROUND

The present disclosure generally relates to health and nutrition. More specifically, the present disclosure relates to shelf-stable fermented dairy products and methods of making the shelf-stable fermented dairy products.

There are many refrigerated food products currently on the market. Refrigeration is the process of cooling or freezing the food product to lower temperatures so as to extend the life of the food product. During storage, bacteria within food products can cause the food product to spoil over time. By refrigerating, a food product can be maintained without spoiling for extended periods of time such as weeks or months. Typical food products requiring refrigeration include meat and dairy products including fermented dairy products such as yogurt. However, food products that require refrigeration are generally more costly to store than non-refrigerated foods due to the energy costs associated with refrigeration or freezing.

Shelf-stable foods are foods that would normally be stored refrigerated but have been processed so that they can be safely stored at room or ambient temperature for long shelf life. Various food preservation and packaging techniques are used to extend a food's shelf life. Some of these techniques include decreasing the amount of available water in a food product, increasing its acidity, or irradiating or otherwise sterilizing the food product and then sealing it in an air-tight container. For some foods alternative ingredients can be used. However, different types of food products each required specific techniques to increase the food's shelf life without unacceptably changing its taste or texture.

A fermented dairy product such as yogurt is very susceptible to protein coagulation when heated following the fermentation process. Furthermore, a fermented dairy product introduces a multitude of challenges in maintaining shelf-stability while providing the appropriate taste and texture profiles. Therefore, there is a need for a shelf-stable fermented dairy product that is appealing to a consumer and does not need to be refrigerated.

### BRIEF DESCRIPTION OF THE FIGURES

FIG. 1 illustrates a yogurt viscosity comparison between three different yogurt products.

FIG. 2 illustrates a yogurt texture comparison between three different yogurt products.

### DETAILED DESCRIPTION

Shelf-stable fermented dairy products and methods of making the shelf-stable fermented dairy products are provided. In a general embodiment, the present disclosure provides a shelf-stable fermented dairy product including a fermented dairy component, a stabilizer, and a puree composition. The dairy products have a pH ranging from about 4.4 to about 4.5.

In an embodiment of the method, the shelf-stable fermented dairy product has a flavor liking score of at least 5 based on a 9-point hedonic scale of a quantitative central location test. The shelf-stable fermented dairy product can have a sweetness liking score of at least 5 based on a 9-point hedonic scale of a quantitative central location test. The shelf-stable fermented dairy product can have a tartness liking score of at least 5 based on a 9-point hedonic scale of a quantitative central location test. In addition, the shelf-stable fermented dairy product can have a texture liking score of at least 5 based on a 9-point hedonic scale of a quantitative central location test.

In an embodiment of the method, adding the stabilizer to the fermented dairy component under shear comprises stabilizing proteins in the fermented dairy component by coating with the stabilizer. The fermented dairy mixture can be heated to a temperature above 200° F. In addition, the method can be performed under aseptic conditions.

An advantage of the present disclosure is to provide an improved shelf-stable fermented dairy product that is shelf-stable for at least 3 months or longer.

Yet another advantage of the present disclosure is to provide an improved method of making a shelf-stable fermented dairy product.

Still another advantage of the present disclosure is to provide a commercially sterile product that is not grainy and maintains this characteristic over the shelf life of the product.

Another advantage of the present disclosure is to provide a method for making shelf-stable fermented dairy products that is easily adaptable to commercial processes typically in place for heat processed dairy-based products (e.g., such a pudding).

Yet another advantage of the present disclosure is to provide a method for making shelf-stable fermented dairy products having the ability to add a variety of other ingredients to the shelf-stable fermented dairy product without impacting the finished product stability as it relates to the protein matrix of the shelf-stable fermented dairy product.

Additional features and advantages are described herein, and will be apparent from the following Detailed Description.

As used in this disclosure and the appended claims, the singular forms “a,” “an” and “the” include plural referents unless the context clearly dictates otherwise. Thus, for example, reference to “an amino acid” includes a mixture of two or more amino acids, and the like.

As used herein, “about” is understood to refer to numbers in a range of numerals. Moreover, all numerical ranges herein should be understood to include all integer, whole or fractions, within the range.

As used herein the term “amino acid” is understood to include one or more amino acids. The amino acid can be, for example, alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine, valine, or combinations thereof.

As used herein, the term “antioxidant” is understood to include any one or more of various substances such as beta-carotene (a vitamin A precursor), vitamin C, vitamin E, and selenium that inhibit oxidation or reactions promoted by Reactive Oxygen Species (“ROS”) and other radical and non-radical species. Additionally, antioxidants are molecules capable of slowing or preventing the oxidation of other molecules. Non-limiting examples of antioxidants include carotenoids, coenzyme Q10 (“CoQ10”), flavonoids, glutathione, Goji (wolfberry), hesperidin, lactowolfberry, lignan, lutein, lycopene, polyphenols, selenium, vitamin A, vitamin B₁, vitamin B6, vitamin B₁₂, vitamin C, vitamin D, vitamin E, zeaxanthin, or combinations thereof.

As used herein, “carbohydrate(s)” are meant to include:

Monosaccharides, which include, but are not limited to, Trioses (such as Ketotriose (Dihydroxyacetone); Aldotriose (Glyceraldehyde)); Tetroses, which include Ketotetrose (such as: Erythrulose) and Aldotetroses (such as Erythrose, Threose); Pentoses, which include Ketopentose (such as Ribulose, Xylulose), Aldopentose (such as Ribose, Arabinose, Xylose, Lyxose), Deoxy sugar (such as Deoxyribose); Hexoses, which include Ketohexose (such as Psicose, Fructose, Sorbose, Tagatose), Aldohexose (such as Allose, Altrose, Glucose, Mannose, Gulose, Idose, Galactose, Talose), Deoxy sugar (such as Fucose, Fuculose, Rhamnose); Heptose (such as Sedoheptulose); Octose; Nonose (such as Neuraminic acid);

Disaccharides, which include, but are not limited to, Sucrose; Lactose; Maltose; Trehalose; Turanose; Cellobiose; kojiboise; nigerose; isomaltose; and palatinose;

Trisaccharides, which include, but are not limited to, Melezitose and Maltotriose;

Oligosaccharides, which include, but are not limited to, corn syrups and maltodextrin; and

Polysaccharides, which include, but are not limited to, glucan (such as dextrin, dextran, beta-glucan), glycogen, mannan, galactan, and starch (such as those from corn, wheat, tapioca, rice, and potato, including Amylose and Amylopectin. The starches can be natural or modified or gelatinized); or combinations thereof.

Carbohydrates are also understood to include sources of sweeteners such as honey, maple syrup, glucose (dextrose), corn syrup, corn syrup solids, high fructose corn syrups, crystalline fructose, juice concentrates, and crystalline juice.

As used herein, non-limiting examples of sources of ω-3 fatty acids such as α-linolenic acid (“ALA”), docosahexaenoic acid (“DHA”) and eicosapentaenoic acid (“EPA”) include fish oil, krill, poultry, eggs, or other plant or nut sources such as flax seed, walnuts, almonds, algae, modified plants, etc.

As used herein, an “F₀-value” or “F₀=”is the time in minutes (at a reference temperature of 250° F. and with a z=18° F.) to provide an appropriate spore destruction (minimum health protection or commercial sterility).

As used herein, “food grade micro-organisms” means micro-organisms that are used and generally regarded as safe for use in food.

While the terms “individual” and “patient” are often used herein to refer to a human, the present disclosure is not so limited. Accordingly, the terms “individual” and “patient” refer to any animal, mammal or human having or at risk for a medical condition that can benefit from the treatment.

As used herein, “mammal” includes, but is not limited to, rodents, aquatic mammals, domestic animals such as dogs and cats, farm animals such as sheep, pigs, cows and horses, and humans. Wherein the term “mammal” is used, it is contemplated that it also applies to other animals that are capable of the effect exhibited or intended to be exhibited by the mammal.

The term “microorganism” is meant to include the bacterium, yeast and/or fungi, a cell growth medium with the microorganism, or a cell growth medium in which microorganism was cultivated.

As used herein, the term “minerals” is understood to include boron, calcium, chromium, copper, iodine, iron, magnesium, manganese, molybdenum, nickel, phosphorus, potassium, selenium, silicon, tin, vanadium, zinc, or combinations thereof.

As used herein, a “non-replicating” microorganism means that no viable cells and/or colony forming units can be detected by classical plating methods. Such classical plating methods are summarized in the microbiology book: James Monroe Jay, et al. 2005. Modern Food Microbiology, 7th ed. Springer Science, New York, N.Y., pp. 790. Typically, the absence of viable cells can be shown as follows: no visible colony on agar plates or no increasing turbidity in liquid growth medium after inoculation with different concentrations of bacterial preparations (‘non replicating’ samples) and incubation under appropriate conditions (aerobic and/or anaerobic atmosphere for at least 24 hours). For example, bifidobacteria such as Bifidobacterium longum, Bifidobacterium lactic and Bifidobacterium breve or lactobacilli, such as Lactobacillus paracasei or Lactobacillus rhamnosus, may be rendered non-replicating by heat treatment, in particular low temperature/long time heat treatment.

As used herein, “phytochemicals” or “phytonutrients” are non-nutritive compounds that are found in many foods. Phytochemicals are functional foods that have health benefits beyond basic nutrition, and are health promoting compounds that come from plant sources. “Phytochemicals” and “Phytonutrients” refers to any chemical produced by a plant that imparts one or more health benefit on the user. Non-limiting examples of phytochemicals and phytonutrients include those that are:
i) phenolic compounds which include monophenols (such as, for example, apiole, carnosol, carvacrol, dillapiole, rosemarinol); flavonoids (polyphenols) including flavonols (such as, for example, quercetin, fingerol, kaempferol, myricetin, rutin, isorhamnetin), flavanones (such as, for example, fesperidin, naringenin, silybin, eriodictyol), flavones (such as, for example, apigenin, tangeritin, luteolin), flavan-3-ols (such as, for example, catechins, (+)-catechin, (+)-gallocatechin, (−)-epicatechin, (−)-epigallocatechin, (−)-epigallocatechin gallate (EGCG), (−)-epicatechin 3-gallate, theaflavin, theaflavin-3-gallate, theaflavin-3′-gallate, theaflavin-3,3′-digallate, thearubigins), anthocyanins (flavonals) and anthocyanidins (such as, for example, pelargonidin, peonidin, cyanidin, delphinidin, malvidin, petunidin), isoflavones (phytoestrogens) (such as, for example, daidzein (formononetin), genistein (biochanin A), glycitein), dihydroflavonols, chalcones, coumestans (phytoestrogens), and Coumestrol; Phenolic acids (such as: Ellagic acid, Gallic acid, Tannic acid, Vanillin, curcumin); hydroxycinnamic acids (such as, for example, caffeic acid, chlorogenic acid, cinnamic acid, ferulic acid, coumarin); lignans (phytoestrogens), silymarin, secoisolariciresinol, pinoresinol and lariciresinol); tyrosol esters (such as, for example, tyrosol, hydroxytyrosol, oleocanthal, oleuropein); stilbenoids (such as, for example, resveratrol, pterostilbene, piceatannol) and punicalagins;
ii) terpenes (isoprenoids) which include carotenoids (tetraterpenoids) including carotenes (such as, for example, α-carotene, β-carotene, γ-carotene, δ-carotene, lycopene, neurosporene, phytofluene, phytoene), and xanthophylls (such as, for example, canthaxanthin, cryptoxanthin, aeaxanthin, astaxanthin, lutein, rubixanthin); monoterpenes (such as, for example, limonene, perillyl alcohol); saponins; lipids including: phytosterols (such as, for example, campesterol, beta sitosterol, gamma sitosterol, stigmasterol), tocopherols (vitamin E), and ω-3, -6, and -9 fatty acids (such as, for example, gamma-linolenic acid); triterpenoid (such as, for example, oleanolic acid, ursolic acid, betulinic acid, moronic acid);
iii) betalains which include Betacyanins (such as: betanin, isobetanin, probetanin, neobetanin); and betaxanthins (non glycosidic versions) (such as, for example, indicaxanthin, and vulgaxanthin);
iv) organosulfides, which include, for example, dithiolthiones (isothiocyanates) (such as, for example, sulphoraphane); and thiosulphonates (allium compounds) (such as, for example, allyl methyl trisulfide, and diallyl sulfide), indoles, glucosinolates, which include, for example, indole-3-carbinol; sulforaphane; 3,3′-diindolylmethane; sinigrin; allicin; alliin; allyl isothiocyanate; piperine; syn-propanethial-S-oxide;
v) protein inhibitors, which include, for example, protease inhibitors;
vi) other organic acids which include oxalic acid, phytic acid (inositol hexaphosphate); tartaric acid; and anacardic acid; or
vii) combinations thereof.

As used herein, a “prebiotic” is a food substance that selectively promotes the growth of beneficial bacteria or inhibits the growth or mucosal adhesion of pathogenic bacteria in the intestines. They are not inactivated in the stomach and/or upper intestine or absorbed in the gastrointestinal tract of the person ingesting them, but they are fermented by the gastrointestinal microflora and/or by probiotics. Prebiotics are, for example, defined by Glenn R. Gibson and Marcel B. Roberfroid. 1995. Dietary Modulation of the Human Colonic Microbiota: Introducing the Concept of Prebiotics. J. Nutr. 125:1401-1412. Non-limiting examples of prebiotics include acacia gum, alpha glucan, arabinogalactans, beta glucan, dextrans, fructooligosaccharides, fucosyllactose, galactooligosaccharides, galactomannans, gentiooligosaccharides, glucooligosaccharides, guar gum, inulin, isomaltooligosaccharides, lactoneotetraose, lactosucrose, lactulose, levan, maltodextrins, milk oligosaccharides, partially hydrolyzed guar gum, pecticoligosaccharides, resistant starches, retrograded starch, sialooligosaccharides, sialyllactose, soyoligosaccharides, sugar alcohols, xylooligosaccharides, or their hydrolysates, or combinations thereof.

As used herein, probiotic micro-organisms (hereinafter “probiotics”) are food-grade microorganisms (alive, including semi-viable or weakened, and/or non-replicating), metabolites, microbial cell preparations or components of microbial cells that could confer health benefits on the host when administered in adequate amounts, more specifically, that beneficially affect a host by improving its intestinal microbial balance, leading to effects on the health or well-being of the host. Salminen S, et al. 1999. Probiotics: how should they be defined? Trends Food Sci. Technol. 10: 107-10. In general, it is believed that these micro-organisms inhibit or influence the growth and/or metabolism of pathogenic bacteria in the intestinal tract. The probiotics may also activate the immune function of the host. For this reason, there have been many different approaches to include probiotics into food products. Non-limiting examples of probiotics include Aerococcus, Aspergillus, Bacillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or combinations thereof.

The terms “protein,” “peptide,” “oligopeptides” or “polypeptide,” as used herein, are understood to refer to any composition that includes, a single amino acids (monomers), two or more amino acids joined together by a peptide bond (dipeptide, tripeptide, or polypeptide), collagen, precursor, homolog, analog, mimetic, salt, prodrug, metabolite, or fragment thereof or combinations thereof. For the sake of clarity, the use of any of the above terms is interchangeable unless otherwise specified. It will be appreciated that polypeptides (or peptides or proteins or oligopeptides) often contain amino acids other than the 20 amino acids commonly referred to as the 20 naturally occurring amino acids, and that many amino acids, including the terminal amino acids, may be modified in a given polypeptide, either by natural processes such as glycosylation and other post-translational modifications, or by chemical modification techniques which are well known in the art. Among the known modifications which may be present in polypeptides of the present inventive concept(s) include, but are not limited to, acetylation, acylation, ADP-ribosylation, amidation, covalent attachment of a flavanoid or a heme moiety, covalent attachment of a polynucleotide or polynucleotide derivative, covalent attachment of a lipid or lipid derivative, covalent attachment of phosphatidylinositol, cross-linking, cyclization, disulfide bond formation, demethylation, formation of covalent cross-links, formation of cystine, formation of pyroglutamate, formylation, gamma-carboxylation, glycation, glycosylation, glycosylphosphatidyl inositol (“GPI”) membrane anchor formation, hydroxylation, iodination, methylation, myristoylation, oxidation, proteolytic processing, phosphorylation, prenylation, racemization, selenoylation, sulfation, transfer-RNA mediated addition of amino acids to polypeptides such as arginylation, and ubiquitination. The term “protein” also includes “artificial proteins” which refers to linear or non-linear polypeptides, consisting of alternating repeats of a peptide.

Non-limiting examples of proteins include dairy based proteins, plant based proteins, animal based proteins and artificial proteins. Dairy based proteins include, for example, casein, caseinates (e.g., all forms including sodium, calcium, potassium caseinates), casein hydrolysates, whey (e.g., all forms including concentrate, isolate, demineralized), whey hydrolysates, milk protein concentrate, and milk protein isolate. Plant based proteins include, for example, soy protein (e.g., all forms including concentrate and isolate), pea protein (e.g., all forms including concentrate and isolate), canola protein (e.g., all forms including concentrate and isolate), other plant proteins that commercially are wheat and fractionated wheat proteins, corn and it fractions including zein, rice, oat, potato, peanut, green pea powder, green bean powder, and any proteins derived from beans, lentils, and pulses. Animal based proteins may be selected from the group consisting of beef, poultry, fish, lamb, seafood, or combinations thereof.

As used herein, the term “shelf-stable” means capable of being stored at room temperature (e.g., about 20° C. to about 25° C.) for long periods (e.g., more than 3 months) without becoming spoiled or rotten.

As used herein, a “synbiotic” is a supplement that contains both a prebiotic and a probiotic that work together to improve the microflora of the intestine.

As used herein, “titratable acidity” measures the amount of alkali required to neutralize the acidic components of a given quantity of product and is expressed as a percentage of an acid (e.g., lactic acid).

As used herein the term “vitamin” is understood to include any of various fat-soluble or water-soluble organic substances (non-limiting examples include vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, folic acid and biotin) essential in minute amounts for normal growth and activity of the body and obtained naturally from plant and animal foods or synthetically made, pro-vitamins, derivatives, analogs.

In an embodiment, a source of vitamins or minerals can include at least two sources or forms of a particular nutrient. This represents a mixture of vitamin and mineral sources as found in a mixed diet. Also, a mixture may also be protective in case an individual has difficulty absorbing a specific form, a mixture may increase uptake through use of different transporters (e.g., zinc, selenium), or may offer a specific health benefit. As an example, there are several forms of vitamin E, with the most commonly consumed and researched being tocopherols (alpha, beta, gamma, delta) and, less commonly, tocotrienols (alpha, beta, gamma, delta), which all vary in biological activity. There is a structural difference such that the tocotrienols can more freely move around the cell membrane; several studies report various health benefits related to cholesterol levels, immune health, and reduced risk of cancer development. A mixture of tocopherols and tocotrienols would cover the range of biological activity.

As used herein, a “z-value” or “z=” is indicative of the change in the death rate of an organism based on temperature. It is the number of degrees between a 10-fold change (1 log cycle) in an organism's resistance.

Typical baby milk and drink products have a pH ranging from about 4.1 to about 4.2 and are manufactured using heat treatments that provide an elevated temperature for a specific amount of time (e.g., 101° C. for 49 seconds). This combination of heat treatment and acidic pH has been established to ensure the microbiological safety and product stability during the shelf life of one year at room temperature. However, some baby milk and drink products include formulations having increased fruit pulps, which can increase the pH of the product to a range between about 4.3 and 4.5. As a result, such products are perceived as tasting less sour. However, because of the reduced acidity, the microbiological safety and stability of the products can be compromised.

The spore-forming bacteria are an important group of microorganisms in the food industry. They are genetically very diverse. However, some acid tolerant spore-formers share common characteristics that are relevant for the processing of acid and acidified, ambient stable products: growth in products with pH below 4.6, formation of heat-resistant endospores, and wide distribution in the environment, especially in soil, vegetables, fruits, spices, and milk products.

The main components of the acid and acidified baby milk and drink formulations, namely fruit preparations and fresh yoghurt or white cheese may contain psychrotrophic, mesophilic and thermophilic spore concentrations that are generally low but may fluctuate depending on the season, origin, processing and supplier. This natural and variable spore contamination has been a potential concern for the manufacture of acid and acidified baby milk and drink products because spores may survive the heat treatment and be able to germinate and grow in the product.

Applicant has surprisingly found, however, that it is possible to manufacture a shelf-stable fermented dairy product having a pH ranging from about 4.4 to 4.5 that are safe for the intended shelf life from the risk of pathogen spore-former survival and outgrowth during ambient temperature distribution.

More specifically, Applicant has found that the pH of dairy containing commercially sterile products can be raised to a maximum of about 4.5. The raising of the pH can be completed, for example, with (i) a minimum titratable acidity (organic acids) of about 0.6%; (ii) maximum mesophilic spores in raw materials of about 100 per gram material; (iii) maximum thermophilic spores in raw materials of about 100 per gram material; and (iv) a minimum thermal process of F₀=10.

Accordingly, shelf-stable fermented dairy products having a pH ranging from about 4.4 to about 4.5 and methods of making the shelf-stable fermented dairy products are provided. The shelf-stable fermented dairy products can be shelf-stable with developmentally appropriate textures and taste profiles. In a general embodiment, the present disclosure provides a shelf-stable fermented dairy product including a fermented dairy component, a physical or chemical stabilizer, and a puree composition. The fermented dairy component can be, for example, dehydrated or fresh yogurt, sour cream, buttermilk, kefir, cheese, or a combination thereof. Other suitable shelf-stable fermented dairy components can also be used to make the shelf-stable fermented dairy products in embodiments of the present disclosure.

As used herein, the term “shelf-stable” means capable of being stored at room temperature (e.g., about 20 ° C. to about 25 ° C.) for long periods (e.g., more than 3 months) without becoming spoiled or rotten. Typical fermented dairy products normally need to be stored refrigerated, but the shelf-stable fermented dairy products in embodiments of the present disclosure have been processed so that they can be safely stored in a sealed container at room or ambient temperature for a usefully long shelf life without unacceptably changing their taste or texture. The fermented dairy product produced can be shelf-stable, for example, for more than 3 months, 6 months, 12 months, 18 months, etc.

In an embodiment, the shelf-stable fermented dairy product of the present inventive concept(s) has a taste and flavor profile that yields a liking score from a sensory perspective that is significantly higher than other shelf stable dairy compositions and refrigerated dairy compositions (e.g., obtains or receives from a consumer) a flavor liking score of at least 5, 6, 7, 8 or 9 based on a 9-point hedonic scale of a quantitative central location test. The 9-point hedonic scale is one of the most widely used scale for measuring food acceptability. For example, the 9-point hedonic scale assigns points 1-9 based on user preferences for a food product as follows: Like Extremely—9; Like Very Much—8; Like Moderately—7; Like Slightly—6; Neither Like nor Dislike—5; Dislike Slightly—4; Dislike Moderately—3; Dislike Very Much—2; and Dislike Extremely—1.

Central location tests are product marketing tests performed in controlled environments, contrary to home-user tests, which take place where the products would actually be used. Central location tests can be conducted in a premises such as a room in a shopping mall. Consumers can be recruited to participate in a research product on the shopping mall and the research can be conducted and completed at that time. The consumers can be children or adults. The number of consumers can vary depending on the statistical analysis performed. It should be appreciated that the number of consumers should be enough to provide a statistically relevant test.

The shelf-stable fermented dairy product can have a score of at least 5, 6, 7, 8 or 9 for other characteristics based on a 9-point hedonic scale of a quantitative central location test. For example, the characteristics can include appearance liking, color liking, flavor liking, fruit flavor liking, sweetness liking, tartness liking, texture liking or consistency liking.

In an embodiment, the stabilizer is a physical or chemical stabilizer and is a hydrocolloid or a high gelling whey protein concentrate. The hydrocolloid can be pectin, gelatin, carrageenan, agar, acacia gum, sodium alginate, xanthan gum, locust bean gum, carboxymethyl cellulose (CMC) or a combination thereof. The stabilizer can range from about 0.001% to about 10% by weight, such as (but not limited to) from about 0.01% to 5%, or from about 0.2% to about 0.5%.

In an embodiment, the shelf-stable fermented dairy product has a pH ranging from about 3.8 to about 4.6, or from about 3.9 to about 4.5, or from about 4.0 to about 4.4, or from about 4.1 to about 4.3, or about 4.2. In an embodiment, the shelf-stable fermented dairy product has a pH of about 4.4. In another embodiment, the shelf-stable fermented dairy product has a pH of about 4.5.

The present disclosure offers a surprisingly significant difference and preference in viscosity and texture as seen in Tables 1-9 below. Viscosity is measured using a Brookfield RV #6 Spindle at 5 RPM, 10 seconds and ranges from about at least 15,000 centipoise, or from about 20,000 centipoise to about 70,000 centipoise, or from about 35,000 centipoise to about 60,000 centipoise. Texture is measured using a TMS-Pro Texture Analzyer-Serial #07-1066-08 and ranges from about 2.75 Newtons to about 5.000 Newtons, or from about 3.000 Newtons to about 5.000 Newtons, or from about 3.200 Newtons to about 4.800 Newtons, or from about 3.400 Newtons to about 4.500 Newtons.

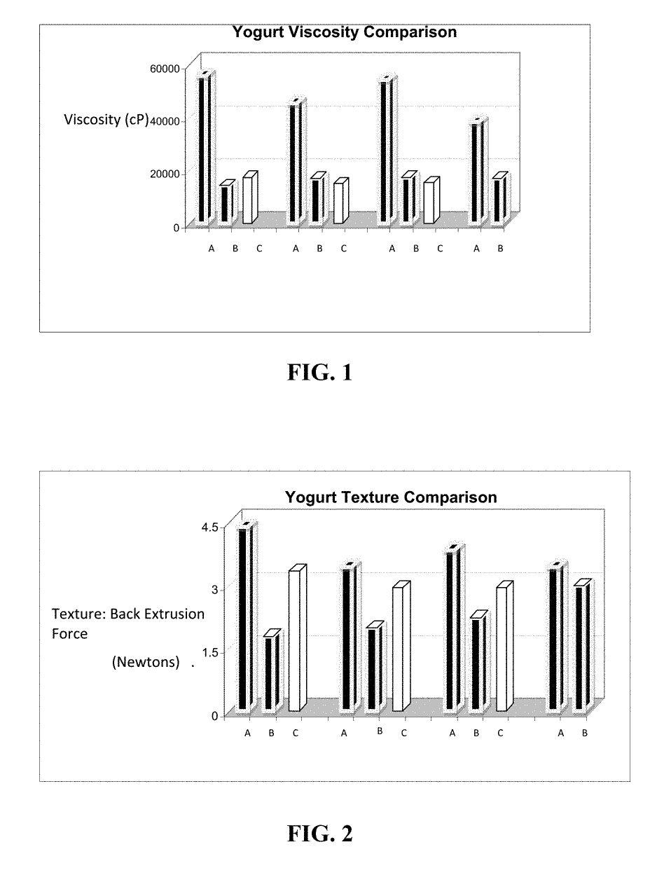

In a comparative analysis of flavored yogurts having a pH of about 4.3 (A) with yogurts of similar flavor in another shelf stable yogurt product (B) and a refrigerated yogurt product (C), the results showed a statistically significant difference between the viscosity and texture of the flavored yogurts having a pH of about 4.3 and the two other products, as detailed in Tables 1-9 and FIGS. 1-2 below.

TABLE 1

| | Product | Viscosity | stdev | Texture | stdev |
|---|---|---|---|---|---|
| Strawberry | A - Strawberry | 55552 | 1161 | 4.3950 | 0.1605 |
| | B - Shelf stable | 14120 | 1072 | 1.7822 | 0.0621 |
| | Strawberry | | | | |
| | C - Refrigerated | 17240 | 1218 | 3.3441 | 0.1300 |
| | Strawberry | | | | |
| Banana | A - Banana | 45416 | 1253 | 3.4339 | 0.1135 |
| | B - Shelf Stable | 16912 | 1398 | 1.9781 | 0.0816 |
| | Banana | | | | |
| | C - Refrigerated | 14928 | 1026 | 2.9344 | 0.1307 |
| | Banana | | | | |
| Pear | A - Pear | 53976 | 3047 | 3.8363 | 0.1618 |
| | B - Shelf stable Pear | 17224 | 1934 | 2.2267 | 0.2410 |
| | C - Refrigerated | 15200 | 1570 | 2.9463 | 0.2703 |
| | Pear | | | | |
| Peach | A - Peach | 38064 | 1833 | 3.4337 | 0.1332 |
| | B - Refrigerated | 16800 | 2006 | 2.9830 | 0.2113 |
| | Peach | | | | |

TABLE 2
Texture-Strawberry

| | Brand | | |
|---|---|---|---|
| | A | B | C |
| Texture | 4.40 BC | 1.78 | 3.3 B |

TABLE 3
Texture-Banana

| | Brand | | |
|---|---|---|---|
| | A | B | C |
| Texture | 3.43 BC | 1.98 | 2.93 B |

TABLE 4
Texture-Pear

| | Brand | | |
|---|---|---|---|
| | A | B | C |
| Texture | 3.84 BC | 2.23 | 2.95 B |

TABLE 5
Texture-Peach

Brand

| | A | B |
|---|---|---|
| Texture | 3.43 B | 2.98 |

TABLE 6
Viscosity-Strawberry

| | Brand | | |
|---|---|---|---|
| | A | B | C |
| Viscosity | 55552 BC | 14120 | 17240 B |

TABLE 7
Viscosity-Banana

| | Brand | | |
|---|---|---|---|
| | A | B | C |
| Viscosity | 45416 BC | 16912 C | 14928 |

TABLE 8
Viscosity-Pear

| | Brand | | |
|---|---|---|---|
| | A | B | C |
| Viscosity | 53976 BC | 17224 C | 15200 |

TABLE 9
Viscosity-Peach

Brand

| | A | B |
|---|---|---|
| Viscosity | 38064 B | 16800 |

In the present disclosure, sensory tests were conducted by trained sensory panelists with a Descriptive Analysis using a 100 point Unstructured Line Scale.

The shelf-stable fermented dairy product can also include acidulants including but not limited to lactic acid, malic acid, citric acid, tartaric acid, phosphoric acid, glocono delta lactone in an amount of about 0.01% to about 2% by weight, such as (but not limited to) from about 0.1-1% by weight.

In an embodiment, the composition of the present disclosure can include sugar in an amount up to about 20% by weight, such as (but not limited to) from about 3% to 15% by weight, or from about 5% to about 10% by weight. The shelf-stable fermented dairy product can also be sugar free and include sugarless sweeteners such as maltitol, mannitol, xylitol, hydrogenated starch hydrolysates, sorbitol, lactitol, erythritol and the like, alone or in combination.

High intensity artificial or natural sweeteners can also be used in the shelf-stable fermented dairy product. Preferred (but non-limiting) sweeteners include, but are not limited to sucralose, aspartame, salts of acesulfame, alitame, saccharin and its salts, cyclamic acid and its salts, glycyrrhizin, stevioside, dihydrochalcones, thaumatin, monellin, and the like, alone or in combination.

In an embodiment, the puree composition includes a pureed fruit including but not limited to apple, orange, pear, peach, strawberry, banana, cherry, pineapple, kiwi, grape, blueberry, raspberry, mango, guava, cranberry, blackberry or a combination thereof. The fruit can be present in an amount ranging from about 0% to about 80% by weight, such as (but not limited to) from about 3% to about 20% by weight, or from about 5% to about 10% by weight. Flavor components in general can range from about 0% to about 10%, such as (but not limited to) from about 0.001% to about 5%, or from about 0.1% to about 4% by weight.

In an embodiment, the composition of the present disclosure can include a vegetable ingredient selected from the group including but not limited to sweet potatoes, carrots, peas, green beans and squash.

In an embodiment, the shelf-stable fermented dairy product further includes one or more prebiotics. As used herein, a prebiotic is a selectively fermented ingredient that allows specific changes, both in the composition and/or activity in the gastrointestinal microflora that confers benefits upon host well-being and health. The prebiotics may be selected from the group consisting of acacia gum, alpha glucan, arabinogalactans, beta glucan, dextrans, fructooligosaccharides, galactooligosaccharides, galactomannans, gentiooligosaccharides, glucooligosaccharides, guar gum, inulin, isomaltooligosaccharides, lactosucrose, lactulose, levan, maltodextrins, partially hydrolyzed guar gum, pecticoligosaccharides, retrograded starch, soyoligosaccharides, sugar alcohols, xylooligosaccharides, or combinations thereof.

In an embodiment, the shelf-stable fermented dairy product further includes one or more probiotics. As used herein, probiotics are defined as microorganisms (e.g., live) that could confer health benefits on the host when administered in adequate amounts. Probiotics may be selected from the group consisting of Aerococcus, Aspergillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or combinations thereof.

In another embodiment, the shelf-stable fermented dairy product further includes one or more amino acids. Non-limiting examples of amino acids include Isoleucine, Alanine, Leucine, Asparagine, Lysine, Aspartate, Methionine, Cysteine, Phenylalanine, Glutamate, Threonine, Glutamine, Tryptophan, Glycine, Valine, Proline, Serine, Tyrosine, Arginine, Citrulline, Histidine or combinations thereof.

In an embodiment, the shelf-stable fermented dairy product further includes one or more synbiotics, phytonutrients, antioxidants, vitamins and/or minerals. As used herein, a synbiotic is a supplement that contains both a prebiotic and a probiotic that work together to improve the microflora of the intestine. Non-limiting examples of phytonutrients include quercetin, curcumin and limonin. Antioxidants are molecules capable of slowing or preventing the oxidation of other molecules. Non-limiting examples of antioxidants include vitamin A, carotenoids, vitamin C, vitamin E, selenium, flavonoids, polyphenols, lycopene, lutein, lignan, coenzyme Q10 (“CoQ10”) and glutathione.

Non-limiting examples of vitamins may include Vitamins A, B-complex (such as B-1, B-2, B-6 and B-12), C, D, E and K, niacin and acid vitamins such as pantothenic acid and folic acid and biotin. Non-limiting examples of minerals may include calcium, iron, zinc, magnesium, iodine, copper, phosphorus, manganese, potassium, chromium, molybdenum, selenium, nickel, tin, silicon, vanadium and boron.

Other optional ingredients can be added to make the dairy products sufficiently palatable. For example, the dairy products of the present disclosure can optionally include conventional food additives, such as any of, acidulants, additional thickeners, buffers or agents for pH adjustment, chelating agents, colorants, emulsifiers, excipients, flavor agents, minerals, osmotic agents, pharmaceutically acceptable carriers, preservatives, stabilizers, sugars, sweeteners, texturizers, or combinations thereof. The optional ingredients can be added in any suitable amount.

In an alternative embodiment, the present disclosure provides a method of making a shelf-stable fermented dairy product. The method comprises adding a physical or chemical stabilizer to a fermented dairy component under shear to create a shelf-stable fermented dairy mixture under a temperature range from 33-65° F. at a blending range from 10 to 1,000 rpm, such as (but not limited to) from about 50 to 500 rpm, or from about 100 to about 300 rpm, homogenizing the fermented dairy mixture under a temperature range of from about 33° F. to about 165° F., such as (but not limited to) about 33° F. to about 100° F., or from about 33° F. to about 60° F. and in a single or dual stage homogenizer with pressure range from about 500 psi to about 4000 psi, such as (but not limited to) from about 500 psi to about 3000 psi, or from about 500 psi to about 1500 psi, adding a puree composition to the fermented dairy mixture under a temperature range from about 33° F. to about 165° F. at blending range from 10 to 1,000 rpm, and heat processing the shelf-stable fermented dairy mixture to render the shelf-stable fermented dairy mixture commercially sterile to form the shelf-stable fermented dairy product in a range of from about 10 seconds to about 40 minutes, at the temperature range of about 185° F. to about 240° F. The method can be performed under aseptic conditions.

The present method unexpectedly creates an improved shelf stable dairy product with improved taste, viscosity and texture. Specifically, refrigerated dairy products coagulate over time and temperature and need to be controlled to obtain the correct viscosity for the end product. High sheer and heat are not necessary and not preferred in the prior art methods since natural proteins create viscosity and thickness which coagulate and form a matrix to build the texture and viscosity of the final product. The method of the present disclosure surprisingly provided improved viscosity, texture and taste. While viscosity alone may be adjustable in the prior art refrigerated methods, the combination of the viscosity and texture of the present disclosure provides a surprisingly improved and preferred composition.

The first part of the method involves “stabilizing” protein in the shelf-stable fermented dairy component by coating it with a suitable hydrocolloid (e.g., pectin) or a high gelling whey protein concentrate followed by homogenization of the shelf-stable fermented dairy mixture. This allows the shelf-stable fermented dairy mixture to be heated to sterilization temperatures (e.g., above 185° F.) without coagulating the protein thereby resulting in a smooth textured fermented dairy product.

In an embodiment of the method, one or more thickeners can include but are not limited to physically or chemically modified flours and/or starches from sources such as rice, wheat, oat, barley, tapioca, quinoa, rye, amaranth, corn, or potato. Flavors and/or colors are added to the fermented dairy mixture before the heat processing. The shelf-stable fermented dairy component can be yogurt, sour cream, buttermilk or a combination thereof.

Embodiments of the present disclosure advantageously provide the capability to produce a commercially sterile, shelf-stable fermented dairy product that is not grainy while maintaining this characteristic over the shelf life of the product. Available commercial processes typically in place for heat processed, dairy-based products (e.g., such a pudding) can be used to make the shelf-stable fermented dairy products. Various ingredients can be added to the shelf-stable fermented dairy products during the manufacturing process without impacting finished product stability as it relates to the protein matrix of the shelf-stable fermented dairy products.

### EXAMPLES

By way of example and not limitation, the following examples are illustrative of various embodiments of the present disclosure. The formulations set forth below are provided for exemplification only, and they can be modified by the skilled artisan to the necessary extent, depending on the special features that are looked for.

### Example 1

### Sample Banana Yogurt Formulation

| Material Name | Percent |
|---|---|
| Full Fat Yogurt, Refrigerated | 85.06 |
| Sugar | 5.54 |
| Banana Puree, Deseeded | 5.00 |
| Tapioca Starch Physically Treated | 3.50 |
| Flavor, Banana | 0.54 |
| Pectin | 0.35 |
| Color Turmeric | 0.003 |
| Citric Acid | 0.01 |

### Example 2

### Sample Peach Yogurt Formulation

| Material Name | Percent |
|---|---|
| Full Fat Yogurt, Refrigerated | 85.15 |
| Sugar | 5.55 |
| Peach Puree Concentrate | 3.04 |
| Water to reconstitute puree | 1.86 |
| Tapioca Starch Physically Treated | 3.50 |
| Flavor, Peach | 0.54 |
| Pectin | 0.35 |
| Color, Annatto | 0.01 |
| Citric Acid | 0.01 |

### Example 3

### Yogurt Formulations Having Increased pH Values

Applicant performed several experiments to determine the acceptability of a shelf-stable fermented dairy product with a pH ranging between 4.4 and 4.5. To begin the experiments, Applicant obtained whole milk yogurt (whole pasteurized milk fortified with vitamin D (about 97.8%) and nonfat dry milk (about 2.2%)) with ABY2C culture, and having a pH of 4.46 and a TA of 0.93 at about 37° F. Applicant added a blueberry puree and sodium hydroxide pellets to the whole milk yogurt to achieve a final pH of a first batch of 4.4, and a final pH of a second batch of 4.5. The yogurt was thermally processed at 230° F. for 38 seconds, 20 gpm, and placed into 1 cup sized containers. Applicant evaluated the microbiological clearance of 200 cups for each batch (i.e., 200 cups for the batch having a pH of 4.4 and 200 cups for the batch having a pH of 4.5). Applicant also evaluated the viscosity and texture of 30 cups for each batch.

Microbiological Analysis

Applicant evaluated the microbiological clearance of the collected samples to show that the yogurt was sufficiently processed to be commercially sterile at pH up to 4.5 using standard commercial sterility procedures.

Applicant prepared the media according to the following scheme:

Orange Serum broth, final pH=5.6+/−0.2, 10 ml/tube prepare 4 tubes per sample (duplicate tubes for both aerobic and anaerobic conditions)

Mineral oil, sterilized

10% Tartaric acid (for pH adjustment)

Prepare spread plates:

A. Potato Dextrose agar, pH adjusted to 4.4 and 4.5

B. Potato Dextrose agar, pH 5.6 (not adjusted)

After preparation of the media, the product was incubated at 30° C. for 10 days and then the containers were examined to note any appearance deviations (e.g., swelling, seal integrity, gaps, wrinkles, etc.). The containers were then opened aseptically by using a clean sanitized Laminar Flow Hood for testing, cleaning and sanitizing the containers with a chlorine dip, and using gloved hands to aseptically peel the foil lid to expose the product.

To aseptically transfer the product, approximately two mis of the product were placed into each of four tubes, the designated anaerobic tubes were overlayed with 2 mls of Mineral oil, and incorporation of air was avoided by allowing the mineral oil to run down the tube wall. All subcultures were then incubated for at least 5 days at 30²C prior to declaring negative.

Results:

The aerobic tubes contained a slight haze present just under the surface (estimated ¼ to ½ inch). The anaerobic tubes also displayed a similar but thinner, condensed layer just under the mineral oil. Tubes from each rack and condition were struck to PDa, incubated and declared negative based on absence of growth and microscope work. As a result, all 400 samples, representing products produced at pH 4.4 and 4.5 were determined to be commercially sterile.

Viscosity and Texture Analysis

Batch #1—pH of 4.4

Approximately 16,416 cups of blueberry yogurt were produced having an average pH of 4.466 when tested at 24 hours. To analyze the viscosity of the products, the products were blended by hand for 30 folds, then processed by a Brookfield RV Spindle #6 at 5 RPM for 10 seconds. To analyze the texture, the products were blended by hand for 30 folds, then processed by a TMS Pro Texture Analyzer with a 25 Newton load cell and custom made extrusion plate of 3.5″ height×1.4″ diameter.

The color of the experimental yogurt was darker than standard blueberry yogurt with a pH of 4.3, but the experimental yogurt still had a smooth and creamy texture. The experimental yogurt was found to have 17.5% viscosity, 1.26% oxygen, 26.2% solids, all at 76° F.

Batch #2—pH of 4.5

Approximately 11,904 cups of blueberry yogurt were produced having an average pH of 4.578 when tested at 24 hours. To analyze the viscosity of the products, the products were blended by hand for 30 folds, then processed by a Brookfield RV Spindle #6 at 5 RPM for 10 seconds. To analyze the texture, the products were blended by hand for 30 folds, then processed by a TMS Pro Texture Analyzer with a 25 Newton load cell and custom made extrusion plate of 3.5″ height×1.4″ diameter.

The color of the experimental yogurt was even darker than the blueberry yogurt of batch #1 above, but the experimental yogurt still had a smooth and creamy texture and a very sweet flavor. The experimental yogurt was found to have 21% viscosity, 0.63% oxygen, 26.6% solids, all at 73° F.

It should be understood that various changes and modifications to the presently particular embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A shelf-stable fermented dairy product comprising:
a fermented dairy component, wherein at least a portion of the fermented dairy component comprises one or more proteins;
a stabilizer, wherein the stabilizer is selected from the group consisting of a hydrocolloid, a high gelling whey protein concentrate, and combinations thereof; and
a puree composition;
wherein the shelf-stable fermented dairy product has a pH ranging from about 4.4 to about 4.5;
wherein the shelf-stable fermented dairy product has a viscosity greater than about 20,000 centipoise, a texture from about 3 Newtons to about 5 Newtons, and a sugar content of less than about 20% by weight, and wherein the shelf-stable fermented dairy product is shelf-stable for at least 3 months at a temperature in a range of from about 20° C. to about 25° C.;
wherein the shelf-stable fermented dairy product has at least one of:
(a) a minimum titratable acidity of about 0.6%;
(b) maximum mesophilic spores in raw materials of about 100 per gram material;
(c) maximum thermophilic spores in raw materials of about 100 per gram material; and
(d) a minimum thermal process of Fo=10; and
wherein the shelf-stable fermented dairy product has a pH ranging from about 3.8 to about 4.3 and the stabilizer is present in a range of from about 0.2% to about 0.5% by weight of the shelf-stable fermented dairy product, or wherein the shelf-stable fermented dairy product has a pH ranging from about 4.4 to about 4.5 and the stabilizer is present in a range of from about 0.001% to about 10% by weight of the shelf-stable fermented dairy product.

2. The shelf-stable fermented dairy product according to claim 1, wherein the shelf-stable fermented dairy product has:
a flavor liking score of at least 5 based on a 9-point hedonic scale of a quantitative central location test;
a sweetness liking score of at least 5 based on a 9-point hedonic scale of a quantitative central location test;
a tartness liking score of at least 5 based on a 9-point hedonic scale of a quantitative central location test; and
a texture liking score of at least 5 based on a 9-point hedonic scale of a quantitative central location test.

3. The shelf-stable fermented dairy product according to claim 1, wherein the shelf-stable fermented dairy component is selected from the group consisting of yogurt, sour cream, buttermilk, and combinations thereof.

4. The shelf-stable fermented dairy product according to claim 1, wherein the stabilizer comprises a hydrocolloid selected from the group consisting of pectin, gelatin, carrageenan, agar, acacia gum, sodium alginate, xanthan gum, locust bean gum, carboxymethyl cellulose, and combinations thereof.

5. The shelf-stable fermented dairy product according to claim 1, wherein the puree composition comprises a pureed fruit selected from the group consisting of apple, orange, pear, peach, strawberry, banana, cherry, pineapple, kiwi, grape, blueberry, raspberry, mango, guava, cranberry, blackberry, and combinations thereof.

6. The shelf-stable fermented dairy product of claim 1, wherein the stabilizer is coated on at least a portion of the one or more proteins of the fermented dairy component by adding the stabilizer to the fermented dairy component under shear at a blending rate of from about 50 rpm to about 1,000 rpm and at a temperature ranging from about 33° F. to about 65° F.

7. The shelf-stable fermented dairy product of claim 1, further comprising at least one of:
a prebiotic selected from the group consisting of partially hydrolyzed guar gum, fructooligosaccharides, inulin, lactulose, galactooligosaccharides, acacia gum, soyoligosaccharides, xylooligosaccha rides, isomaltooligosaccharides, gentiooligosaccharides, lactosucrose, glucooligosaccharides, pecticoligosaccharides, resistant starches, sugar alcohols, and combinations thereof;
a probiotic selected from the group consisting of Saccharomyces, Debaromyces, Candida, Pichia, Torulopsis, Aspergillus, Rhizopus, Mucor, Penicillium, Torulopsis, Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus, Lactobacillus, and combinations thereof; and
an amino acid selected from the group consisting of Isoleucine, Alanine, Leucine, Asparagine, Lysine, Aspartate, Methionine, Cvsteine, Phenylalanine, Glutamate, Threonine, Glutamine, Tryptophan, Glycine, Valine, Proline, Serine, Tyrosine, Arginine, Citrulline, Histidine, and combinations thereof.

8. The shelf-stable fermented dairy product of claim 1, further comprising at least one component selected from the group consisting of a synbiotic, a phytonutrient, an antioxidant, a vitamin, a mineral, and combinations thereof.

9. The shelf-stable fermented dairy product of claim 1, further defined as having all of (a)-(d).

10. A method of making a shelf-stable fermented dairy product, the method comprising the steps of:
adding a stabilizer to a fermented dairy component under shear at a blending rate of from about 50 rpm to about 1,000 rpm and at a temperature ranging from about 33° F. to about 65° F. to create a shelf-stable fermented dairy mixture, wherein the fermented dairy component comprises one or more proteins and the blending results in the coating of the stabilizer on at least a portion of the one or more proteins of the fermented dairy component, and wherein the stabilizer is selected from the group consisting of a hydrocolloid, a high gelling whey protein concentrate, and combinations thereof;
homogenizing the fermented dairy mixture to thereby provide a homogenized fermented dairy mixture;
adding a puree composition to the homogenized fermented dairy mixture at a blending rate of from about 10 rpm to about 1,000 rpm to thereby provide a mixture of the puree composition and the homogenized fermented dairy mixture; and
heat processing the mixture of the puree composition and the homogenized fermented dairy mixture to render the fermented dairy mixture commercially sterile to form the shelf-stable fermented dairy product; and
wherein the shelf-stable fermented dairy product has a viscosity greater than about 20,000 centipoise, a texture from about 3 Newtons to about 5 Newtons, and a sugar content of less than about 20% by weight, and wherein the shelf-stable fermented dairy product is shelf-stable for at least 3 months at a temperature in a range of from about 20° C. to about 25° C.;
wherein the shelf-stable fermented dairy product has at least one of:
(a) a minimum titratable acidity of about 0.6%;
(b) maximum mesophilic spores in raw materials of about 100 per gram material;
(c) maximum thermophilic spores in raw materials of about 100 per gram material; and
(d) a minimum thermal process of F₀=10; and
wherein the shelf-stable fermented dairy product has a pH ranging from about 3.8 to about 4.3 and the stabilizer is present in a range of from about 0.2% to about 0.5% by weight of the shelf-stable fermented dairy product, or wherein the shelf-stable fermented dairy product has a pH ranging from about 4.4 to about 4.5 and the stabilizer is present in a range of from about 0.001% to about 10% by weight of the shelf-stable fermented dairy product.

11. The method according to claim 10, wherein the fermented dairy mixture is heated to a temperature above 185° F.

12. The method according to claim 10, wherein the method is performed under aseptic conditions.

13. The method according to claim 10, wherein at least one of a thickener, a flavor, a sweetener, an acidulant, and a color is added to the mixture before the heat processing step.

14. The method according to claim 10, wherein the shelf-stable fermented dairy product has:
a flavor liking score of at least 5 based on a 9-point hedonic scale of a quantitative central location test;
a sweetness liking score of at least 5 based on a 9-point hedonic scale of a quantitative central location test;
a tartness liking score of at least 5 based on a 9-point hedonic scale of a quantitative central location test; and
a texture liking score of at least 5 based on a 9-point hedonic scale of a quantitative central location test.

15. The method according to claim 10, wherein the fermented dairy component is selected from the group consisting of yogurt, sour cream, buttermilk, kefir cheese and combinations thereof.

16. The method according to claim 10, wherein the stabilizer is a hydrocolloid selected from the group consisting of pectin, gelatin, carrageenan, agar, acacia gum, sodium alginate, xanthan gum, locust bean gum, carboxymethyl cellulose, and combinations thereof.

17. The method according to claim 10, wherein the puree composition comprises at least one pureed fruit selected from the group consisting of apple, orange, pear, peach, strawberry, banana, cherry, pineapple, kiwi, grape, blueberry, raspberry, mango, guava, cranberry, blackberry, and combinations thereof.

18. The method according to claim 10, further comprising the step of adding at least one of:
a prebiotic selected from the group consisting of partially hydrolyzed guar gum, fructooligosaccharides, inulin, lactulose, galactooligosaccharides, acacia gum, soyoligosaccharides, xylooligosaccharides, isomaltooligosaccharides, gentiooligosaccharides, lactosucrose, glucooligosaccharides, pecticoligosaccharides, resistant starches, sugar alcohols, and combinations thereof;
a probiotic selected from the group consisting of Saccharomyces, Debaromyces, Candida, Pichia, Torulopsis, Aspergillus, Rhizopus, Mucor, Penicillium, Torulopsis, Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus, Lactobacillus, and combinations thereof; and
an amino acid selected from the group consisting of Isoleucine, Alanine, Leucine, Asparagine, Lysine, Aspartate, Methionine, Cvsteine, Phenylalanine, Glutamate, Threonine, Glutamine, Tryptophan, Glycine, Valine, Proline, Serine, Tyrosine, Arginine, Citrulline, Histidine, and combinations thereof.

19. The method according to claim 10, further comprising the step of adding at least one component selected from the group consisting of a synbiotic, a phytonutrient, an antioxidant, a vitamin, a mineral, and combinations thereof.

20. The method of claim 10, wherein the shelf-stable fermented dairy product is further defined as having all of (a)-(d).
